(19) United States
(12) Patent Application Publication
(10) Pub. No.: US 2010/0004369 A1
(43) Pub. Date: Jan. 7, 2010

(54) LOW DENSITY VISCOELASTIC COMPOSITION HAVING DAMPING PROPERTIES

(75) Inventors: Umesh C. Desai, Wexford, PA (US); Ion Pelinescu, Wexford, PA (US)

Correspondence Address: PPG INDUSTRIES INC;INTELLECTUAL PROPERTY DEPT, ONE PPG PLACE, PITTSBURGH, PA, 15272, US

(73) Assignee: PPG INDUSTRIES OHIO, INC., Cleveland, OH (US)

(21) Appl. No.: 12/165,918

(22) Filed: Jul. 1, 2008

(51) Int. Cl. C08K 3/34; C08L 67/00; C08K 3/26; C08K 3/38

(52) U.S. Cl. 524/405; 524/539; 524/445; 524/449; 524/442; 524/451; 524/424; 524/425

(57) ABSTRACT

Curable compositions are provided comprising:
(a) a polyepoxide containing at least two epoxide groups per molecule;
(b) a thermoplastic polyester polymer;
(c) a curing agent having functional groups reactive with the epoxide groups in (a); and
(d) microspheres comprising expandable microspheres which expand during curing of the composition and/or hollow microspheres. In certain embodiments, the compositions further comprise mineral fillers. Upon curing, the density of the cured compositions with expanded microspheres is less than half of the density of the composition before curing. Cured compositions of the present invention provide improved vibration damping properties at elevated temperatures, making them suitable as fillers for engine blade cavities.

### FIELD OF THE INVENTION

The present invention relates to curable compositions demonstrating vibration damping, including sound damping properties, particularly at elevated temperatures.

### BACKGROUND OF THE INVENTION

Research and development efforts in the aerospace industry are increasingly focused on designing lighter structures without sacrificing structural integrity. In jet engine blade cavities where recent attempts have been made to replace existing metallic honeycomb support in the cavity with vibration damping viscoelastic materials, it is desirable to have low density viscoelastic materials. There are high density commercial viscoelastic compositions based on 100% solid epoxy and high solids waterborne systems based on acrylic, SBR, acrylonitrile, etc., available in the industries, but they are not necessarily suitable for use in aerospace applications because of poor vibration damping at relatively high temperatures and because they have high density. Damping loss factors (reciprocal of quality factor) can be improved in low density systems by using low density hollow beads in an epoxy system, such as that described in U.S. Pat. No. 6,669,447 B2.

Unfortunately, low density hollow spheres provide high volume, resulting in a high volume ratio to the binder system, which produces higher viscosity. It would be desirable to provide curable compositions that have lower viscosity in an uncured wet stage to allow for easier handling, but which produce higher volume and lower density upon curing. In addition, it would be desirable to provide a curable composition having the above-mentioned advantages along with an improved vibration damping loss factor.

### SUMMARY OF THE INVENTION

The present invention is directed to curable compositions comprising:

(a) a polyepoxide containing at least two epoxide groups per molecule;

(b) a thermoplastic polyester polymer;

(c) a curing agent having functional groups reactive with the epoxide groups in (a); and

(d) microspheres comprising expandable microspheres which expand during curing of the composition and/or hollow microspheres. In certain embodiments, the compositions further comprise mineral fillers. Upon curing, the density of the cured compositions with expanded microspheres is less than half of the density of the composition before curing. Cured compositions of the present invention provide improved vibration damping properties at elevated temperatures.

### BRIEF DESCRIPTION OF THE DRAWINGS

FIG. 1 illustrates a Reduced Temperature-Frequency Nomogram (RFN) according to ASTM E756 for the composition of Example 1.

FIG. 2 illustrates a Reduced Temperature-Frequency Nomogram (RFN) according to ASTM E756 for the composition of Example 6.

FIG. 3 illustrates a graph of Material Loss Modulus at a frequency of 1 KHz for the compositions of Examples 1 to 7.

FIG. 4 illustrates a graph of Material Loss factor at a frequency of 1 KHz for the compositions of Examples 1 to 7.

FIG. 5 illustrates a graph of the absorption coefficient for the composition of Example 8.

### DETAILED DESCRIPTION OF THE INVENTION

Other than in any operating examples, or where otherwise indicated, all numbers expressing quantities of ingredients, reaction conditions and so forth used in the specification and claims are to be understood as being modified in all instances by the term “about.” Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

Also, it should be understood that any numerical range recited herein is intended to include all sub-ranges subsumed therein, For example, a range of “1 to 10” is intended to include all sub-ranges between (and including) the recited minimum value of 1 and the recited maximum value of 10, that is, having a minimum value equal to or greater than 1 and a maximum value of equal to or less than 10.

As used in this specification and the appended claims, the articles “a,” “an,” and “the” include plural referents unless expressly and unequivocally limited to one referent.

The various embodiments and examples of the present invention as presented herein are each understood to be non-limiting with respect to the scope of the invention.

As used in the following description and claims, the following terms have the meanings indicated below:

By “polymer” is meant a polymer including homopolymers and copolymers, and oligomers. By “composite material” is meant a combination of two or more differing materials.

The term “curable”, as used for example in connection with a curable composition, means that the indicated composition is polymerizable or cross linkable through functional groups, e.g., by means that include, but are not limited to, thermal (including ambient cure) and/or catalytic exposure.

The term “cure”, “cured” or similar terms, as used in connection with a cured or curable composition, e.g., a “cured composition” of some specific description, means that at least a portion of the polymerizable and/or crosslinkable components that form the curable composition is polymerized and/or crosslinked. Additionally, curing of a polymerizable composition refers to subjecting said composition to curing conditions such as but not limited to thermal curing, leading to the reaction of the reactive functional groups of the composition, and resulting in polymerization and formation of a polymerizate. When a polymerizable composition is subjected to curing conditions, following polymerization and after reaction of most of the reactive end groups occurs, the rate of reaction of the remaining unreacted reactive end groups becomes progressively slower. The polymerizable composition can be subjected to curing conditions until it is at least partially cured. The term “at least partially cured” means subjecting the polymerizable composition to curing conditions, wherein reaction of at least a portion of the reactive groups of the composition occurs, to form a polymerizate. The polymerizable composition can also be subjected to curing conditions such that a substantially complete cure is attained and wherein further curing results in no significant further improvement in polymer properties, such as hardness.

The term “reactive” refers to a functional group capable of undergoing a chemical reaction with itself and/or other functional groups spontaneously or upon the application of heat or in the presence of a catalyst or by any other means known to those skilled in the art.

The curable compositions of the present invention comprise one or more epoxy-functional polymers, each polymer typically having at least two epoxide or oxirane groups per molecule. As used herein, “epoxy-functional polymers” means epoxy-functional oligomers, polymers and/or copolymers. These materials often are referred to as di- or polyepoxides. Generally, the epoxide equivalent weight of the epoxy-functional polymer can range from about 70 to about 4,000, and usually about 140 to about 600, as measured by titration with perchloric acid and quaternary ammonium bromide using methyl violet as an indicator.

Suitable epoxy-functional polymers can be saturated or unsaturated, cyclic or acyclic, aliphatic, alicyclic, aromatic or heterocyclic. The epoxy-functional polymers can have pendant or terminal hydroxyl groups, if desired. They can contain substituents such as halogen, hydroxyl, and ether groups. A useful class of these materials includes polyepoxides comprising epoxy polyethers obtained by reacting an epihalohydrin (such as epichlorohydrin or epibromohydrin) with a di- or polyhydric alcohol in the presence of an alkali. Suitable polyhydric alcohols include polyphenols such as resorcinol; catechol; hydroquinone; bis(4-hydroxyphenyl)-2,2-propane, i.e., bisphenol A; bis(4-hydroxyphenyl)-1,1-isobutane; 4,4-dihydroxybenzophenone; bis(4-hydroxyphenol)-1,1-ethane; bis(2-hydroxyphenyl)-methane and 1,5-hydroxynaphthalene.

Frequently used polyepoxides include diglycidyl ethers of Bisphenol A, such as EPON® 828 epoxy resin which is commercially available from Hexion Specialty Chemicals, Inc. EPON® 828 epoxy resin has a number average molecular weight of about 400 and an epoxy equivalent weight of about 185-192. Other useful polyepoxides include polyglycidyl ethers of polyhydric alcohols, polyglycidyl esters of polycarboxylic acids, polyepoxides that are derived from the epoxidation of an olefinically unsaturated alicyclic compound, polyepoxides containing oxyalkylene groups in the epoxy molecule, epoxy novolac resins, and polyepoxides that are partially defunctionalized by carboxylic acids, alcohol, water, phenols, mercaptans or other active hydrogen-containing compounds to give hydroxyl-containing polymers. These polyepoxides are well known to those skilled in the art and are described in U.S. Pat. No. 4,739,019 at column 2, line 6 through column 3, line 12.

The amount of the epoxy-functional polymer in the curable composition can vary depending in part upon the intended application of the composition. In a typical embodiment, the epoxy-functional polymer is present in an amount ranging from 15 to 85 weight percent of the total weight of the curable composition, usually 25 to 65 weight percent, and often 35 to 55 weight percent.

Typically, the polyepoxides are present as liquids or dispersions, although combinations of liquid and solid epoxy-functional polymers can be used as long as the desired viscosity of the curable composition is obtained from the other components of the composition.

Polyepoxide can also be present in form of an adduct with functional polybutadiene, dimer acid, etc.

The curable composition also comprises one or more essentially thermoplastic polyester polymers. As used herein, “essentially thermoplastic” means that the thermoplastic polymer can contain some percentage of unsaturated units so long as the thermoplastic nature of the polymer is maintained, i.e., it does not react with the other components of the curable composition but rather is present as a blended ingredient. The thermoplastic polyester polymer is intended to retard shrinkage of the composition at the time of curing. In certain embodiments the saturated polyester type of thermoplastic polymer contains no more than about 10 percent by weight of unsaturated units, the percentage being based on the total weight of all of the ingredients of the polyester.

The thermoplastic polyester polymer is typically substantially insoluble in the epoxy-functional polymer. As used herein, “substantially insoluble” means that the mixture of epoxy-functional polymer and thermoplastic polyester polymer forms a heterogeneous phase that can be hazy. Such thermoplastic polymers usually have a glass transition temperature of less than about 80° C. Non-limiting examples of suitable thermoplastic polymers include: saturated polyesters including saturated aliphatic polyesters such as polyneopentyl adipate, polypropylene adipate and poly epsilon-caprolactone; saturated polyester urethanes, and the like.

Usually, the thermoplastic polyester polymer is non-reactive with the curable epoxy-functional polymer or other components in the curable composition. It provides an intermingling soft segment in what is otherwise a stiff epoxy matrix. This mechanism is essential in enhancing vibration damping properties. Also, the thermoplastic polymer is substantially free of aromatic units. “Substantially free of aromatic units” means that the thermoplastic polymer contains no more than 10 percent by weight of aromatic units, the percentage being based upon the total weight of all of the ingredients of the thermoplastic polymer. As used herein, an aromatic unit is intended to mean a six carbon ring having pendant hydrogen atoms, the ring having pi electron orbitals above and below the plane of the ring structure, as in benzene.

Most frequently used thermoplastic polymers are substantially saturated polyesters that satisfy the aforedescribed requirements and are prepared from polyfunctional acids and polyhydric alcohols by methods such as are disclosed in U.S. Pat. No. 4,739,019 at column 3, line 22 through column 5, line 15. Examples of suitable saturated acids for preparing these saturated polyesters include adipic acid, azelaic acid, sebacic acid and the anhydrides thereof where they exist. When some proportion of unsaturation is present, it is commonly introduced by the use of unsaturated polyfunctional acids such as maleic acid and fumaric acid. Commonly utilized polyhydric alcohols are ethylene glycol, propylene glycol, diethylene glycol, dipropylene glycol, butylene glycol, glycerol, trimethylolpropane, pentaerythritol and sorbitol. Typically the polyester is prepared from a diol and a diacid. These polyesters can be modified with oils or fatty acids, i.e., alkyd resins.

The thermoplastic polyester polymer generally has a weight average molecular weight of up to about 200,000, often less than about 20,000, more often less than about 10,000, and most often from about 1,000 to about 8,000 grams per mole. The thermoplastic polymer can be prepared by condensation polymerization methods well known to those skilled in the art.

Generally, the amount of the thermoplastic polyester polymer is effective to reduce shrinkage and enhance vibration damping of the cured composition. In certain embodiments, the thermoplastic polyester polymer is present in the curable composition in an amount ranging from 1 to 45 percent by weight based on the total weight of the composition, often 3 to 30 percent by weight, and more often 5 to 25 percent by weight.

The curable composition of the present invention further comprises one or more contemporaneous and/or latent curing agents having functional groups reactive with the epoxide groups in the epoxy-functional polymer(s).

Useful curing agents include: aliphatic, cycloaliphatic, and aromatic polyfunctional amines such as ethylene diamine, diethylene triamine, triethylene tetraamine, tetraethylene pentamine, 1,4-diaminobutane; 1,3-diaminobutane, hexamethylene diamine, 3-(N-isopropylamino)propylamine, diaminocyclohexane, and polyoxypropylene amines commercially available under the trademark designation JEFFAMINE®; meta-phenylene diamine; p,p′-methylene dianiline, and 1,4-aminonaphthalene; polyurea; polyamides such as those derived from fatty acids, dimerized fatty acids or polymeric fatty acids and aliphatic polyamines, for example, the materials commercially available from Henckel under the trademark designations VERSAMIDE 220 or 125; imidazoles; dicyandiamide; and boron trifluoride complexes such as boron trifluoride monoethylamine complex, boron trifluoride diethylamine complex; boron trifluoride triethylamine complex; boron trifluoride pyridine complex; boron trifluoride benzyldimethylamine complex; boron trifluoride benzylamine, boron trifluoride etherate and curing agents disclosed in U.S. Pat. No. 4,739,019, at column 5, lines 24-62. Latent cure systems may also comprise substituted urea accelerators such as phenyl dimethyl urea, toluene dimethyl urea, cycloaliphatic bisurea available as OMICURE from CVC Specialty Chemicals.

The curing agent is present in latent curable compositions of the present invention in an amount ranging from 1.3 to 15 percent by weight, based on the total weight of the composition,

In a two-package composition according top the present invention, the curing agent may be present in an amount of 1 to 50 percent by weight, based on the weight of polyepoxide present in the composition.

The curable composition of the present invention may further comprise a mineral filler. Examples of fillers that can be present include finely divided minerals such as clay, mica, dolomite, talc, zinc borate, magnesium carbonate, calcium oxide, calcium carbonate, precipitated calcium carbonate, calcium silicate, and/or calcium metasilicate. When present, the mineral filler is used in an amount ranging from 5 to 40 percent by weight based on the total weight of the composition.

In certain embodiments of the present invention, the composition is essentially free of mineral fillers. In particular, the composition may be essentially free of mineral fillers that do not act as thixotropes. For the purposes of this invention, inorganic additive pigments are not considered mineral fillers.

The curable composition of the present invention further comprises expandable microspheres and/or hollow microspheres. Chemical blowing agents that produce open cell foam without any shell can be used in limited quantities. Typically the density of the cured composition is less than 1 g/cc due to the presence of these microspheres. Expandable microspheres expand during curing of the composition such that upon curing, the density of the cured composition with expanded microspheres is lower than the density of the composition before curing. Often, the density of the cured composition is less than half of the density of the composition before curing when expandable microspheres are present. The expandable microspheres in the composition of the present invention usually comprise a thermoplastic polymeric shell containing a volatile liquid propellant. Upon heating to a temperature above the softening point of the polymer and the boiling point of the propellant, the spheres expand to as much as five times their original diameter. The expandable microspheres have a particle size prior to incorporation into the composition ranging from 2 to 50 microns. Grades are selected based on application temperature.

The polymeric shell of the expandable microsphere may be a polymer or copolymer of, for example, vinyl chloride, vinylidene chloride, acrylonitrile, methyl methacrylate, styrene, or mixtures thereof. Suitable propellants include freons, such as trichlorofluoromethane, hydrocarbons, such as n-pentane, isopentane, neopentane, butane, isobutane, or other conventional propellants.

In addition to reducing the density of the composition upon curing, the expandable microspheres prevent shrinkage of the composition during cure, allowing a substrate to which the composition is applied to retain its surface shape and appearance when the composition is used as a coating.

Expandable microspheres such as those described in U.S. Pat. Nos. 4,005,033 and 5,155,138 are suitable for use in the composition of the present invention. Particularly useful expandable and expanded microspheres are available from Akzo Nobel AB under the name EXPANCEL and from Henkel Corporation under the name Dualite.

When present, the expandable microspheres are used in an amount ranging from 1 to 10 percent by weight, usually 2 to 5 percent by weight, based upon total weight of the composition.

As noted above, the composition may further comprise hollow microspheres having rigid or flexible shells. Such microspheres are not expandable, and may be used in addition to or instead of the expandable microspheres. Glass, plastic, and/or ceramic microspheres may be used. Often a combination of glass and ceramic microspheres are used. When present, the hollow microspheres are used in amounts of 1 to 25 percent by weight, based on the total weight of the composition.

Low density microspheres such as the expandable and hollow microspheres discussed above tend to separate from rest of the composition in storage. Thixotropes may be used to keep the composition in a homogeneous phase. Examples of thixotropes are Bentone clay (Bentone from Elementis Specialties), Laponite, polyamide powder (DisparIon from King Industries), etc. The formulated product can be heated up to 60° C. for flowability and easy application. High levels of low density microspheres can cause the composition to exhibit high viscosity even at 60° C., so it may be desirable to formulate for low viscosity while maintaining homogeneity by using low amounts of filler and/or microspheres. However, the uniqueness of certain embodiments of the present invention is due in part to the use of both mineral fillers, which impart high density and mass to the composition needed to enhance vibration damping, and microspheres, which lower the density thereof. Using both appears to be counterintuitive, in view of their opposing effects. Conventional compositions typically do not contain both mineral fillers and microspheres.

The curable compositions of the present invention can include a variety of optional ingredients and/or additives that are somewhat dependent on the particular application of the curable composition, such as pigments including carbon black or graphite, reinforcements, thixotropes, accelerators, surfactants, plasticizers, extenders, oligomers such as urethane and acrylates stabilizers, corrosion inhibitors, diluents, antioxidants, and chemical blowing agents. Suitable thixotropes include fumed silica, bentonite, stearic acid-coated calcium carbonate and fatty acid/oil derivatives. Thixotropes are generally present in an amount of up to about 7 weight percent. Generally, the amount of an inorganic extender can be up to about 50 weight percent based upon the total weight of the curable composition. Optional additional ingredients such as carbon black or graphite, surfactants and corrosion inhibitors are present if required in an amount of less than about 5 weight percent of the total weight of the curable composition.

Diluents and plasticizers can be present in an amount of up to about 50 weight percent of the total weight of the curable composition. Examples of suitable diluents include low molecular weight (from about 100 to about 2000) aliphatic or aromatic ester compounds containing one or more ester linkages, and low molecular weight aliphatic or aromatic ethers containing one or more ether linkages and combinations thereof. Reactive diluents are designed to modify strength and/or adhesion of the cured composition, such as aliphatic and/or aromatic mono, di, or tri epoxides having a weight average molecular weight of about 300 to about 1500, can be present in the range of up to about 30 weight percent of the total weight of the curable composition (preferably 5 to 10 percent).

The compositions of the present invention are typically liquid. By “liquid” is meant that the compositions have a viscosity that allows them to be at least extrudable. The compositions may have a viscosity that allows them to be at least pumpable, and often the compositions have a viscosity that allows them to be at least sprayable, Often the composition can be warm applied, for example, at a temperature of 50° C. to 60° C. to facilitate pumping, spraying, or extruding through a nozzle.

Liquid compositions that are suitable for use in the present invention include liquid resin systems that are 100 percent solids, liquid resins that are dissolved or dispersed in a liquid medium, and solid particulate resins that are dispersed in a liquid medium. Liquid media may be aqueous based or organic solvent based.

The curable compositions of the present invention can be prepared in a number of ways, including as a one-package composition with a latent curing agent or as a two-package composition, typically curable at ambient temperature. Two package curable compositions are typically prepared by mixing the two packages immediately before use. A one-package composition can be prepared in advance of use and stored. Note that expandable microspheres require heat for expansion, and are most effective in compositions that undergo a heated cure.

The preparation of the curable composition can be in a manner similar to that of U.S. Pat. No. 4,739,019, at column 6, lines 2-62, using mixing equipment known to those skilled in the art such as triaxial, Littleford, Sigma, and Hockmeyer mixers.

Substrates to which compositions of the present invention may be applied include rigid metal substrates such as titanium, ferrous metals, aluminum, aluminum alloys, copper, and other metal and alloy substrates. Non-limiting examples of useful steel materials include cold rolled steel, galvanized (zinc coated) steel, electrogalvanized steel, stainless steel, pickled steel, zinc-iron alloy such as GALVANNEAL, and combinations thereof. Combinations or composites of ferrous and non-ferrous metals can also be used.

When the composition is used in automotive applications, the thickness of the automotive substrate typically ranges from 0.254 to 3.18 millimeters (mm) (10 to 125 mils), typically 0.6 to 1.2 mm (23.6 to 47.2 mils) although the thickness can be greater or less, as desired. The width of a coil strip generally ranges from 30.5 to 183 centimeters (12 to 72 inches), although the width of the substrate can vary depending upon its shape and intended use.

The compositions of the present invention are particularly suitable as filler material for the hollow cavities of engine blades, A typical jet engine turbine blade comprises solid metal (such as titanium or titanium alloy) with concave and convex wall portions, creating a hollow cavity in the middle. Conventionally this cavity is supported by metallic honeycomb structures. Compositions of the present invention may be used to fill the cavity, replacing the honeycomb structure and providing vibration damping while retaining the stiffness of the structure.

Before depositing any treatment or coating compositions upon the surface of the substrate, it is common practice, though not necessary, to remove foreign matter from the surface by thoroughly cleaning and degreasing the surface. Such cleaning typically takes place after forming the substrate (stamping, welding, etc.) into an end-use shape. The surface of the substrate can be cleaned by physical or chemical means, such as mechanically abrading the surface or cleaning/degreasing with commercially available alkaline or acidic cleaning agents which are well known to those skilled in the art, such as sodium metasilicate and sodium hydroxide. A non-limiting example of a cleaning agent is CHEMKLEEN 163, an alkaline-based cleaner commercially available from PPG Industries, Inc.

Following the cleaning step, the substrate may be rinsed with deionized water or an aqueous solution of rinsing agents in order to remove any residue. The substrate can be air dried, for example, by using an air knife, by flashing off the water by brief exposure of the substrate to a high temperature or by passing the substrate between squeegee rolls.

The substrate to which the composition of the present invention is applied may be a bare, cleaned surface; it may be oily, pretreated with one or more pretreatment compositions, and/or prepainted with one or more coating compositions, primers, etc., applied by any method including, but not limited to, electrodeposition, spraying, dip coating, roll coating, curtain coating, and the like.

The composition may be applied to the substrate by one or more of a number of methods including spraying, extruding, brushing, or by hand with a blade. The composition has a viscosity that allows it to be at least extrudable. In a particular embodiment wherein the composition is used to fill a cavity of a hollow engine blade, the composition is most easily applied by extruding through an opening into the cavity.

The compositions can be cured by allowing them to stand at ambient temperature, or a combination of ambient temperature cure and baking, or by baking alone. The compositions can be cured at ambient temperature typically in a period ranging from about 24 hour to about 36 hours. If ambient temperature and baking are utilized in combination, the composition is typically allowed to stand for a period up to 24 hours followed by baking at a temperature of from about 75° C. to about 200° C., often from about 150° C. to about 180° C., for a period of time ranging from about 20 minutes to about 1 hour.

In certain embodiments of the present invention, after application of the composition of the present invention to a substrate and upon curing, the composition demonstrates a Material Loss Modulus of at least 2000 PSI at least one point within the temperature range of 32° F. (0° C.) to 225° F. (107.2° C.) and at 1 KHz frequency. Certain compositions of the present invention may demonstrate a Material Loss Modulus of at least 2000 PSI across at least one entire temperature range, such as, for example, within the temperature range of 75° F. (23.9° C.) to 165° F. (73.9° C.). Compositions of the present invention may additionally demonstrate a Material Loss Modulus of at least 2000 PSI outside the temperature range of 32° F. (0° C.) to 225° F. (107.2° C.), such as below 32° F. (0° C.) and/or above 225° F. (107.2° C.). Compositions of the present invention typically demonstrate a peak Material Loss Modulus below 175° F. (79.4° C.) at 1 KHz frequency.

In certain embodiments of the present invention, after application of the composition of the present invention to a substrate and upon curing, the composition demonstrates a Material Loss Factor of at least 0.04 at least one point within the temperature range of 115° F. (46.1° C.) to 225° F. (107.2° C.) and at 1 KHz frequency. Again, certain compositions of the present invention may demonstrate a Material Loss Factor of at least 0.04 across at least one entire temperature range within the broad range above. Compositions of the present invention may additionally demonstrate a Material Loss Factor of at least 0.04 outside the temperature range of 115° F. (46.1° C.) to 225° F. (107.2° C.).

In certain embodiments of the present invention, after application of the composition of the present invention to a substrate and upon curing, the composition demonstrates an absorption coefficient of 0.3 or greater at least one frequency within the range of 100 to 6300 Hz.

The following examples are intended to illustrate various embodiments of the invention, and should not be construed as limiting the invention in any way.

### EXAMPLES

Comparative Example 1 demonstrates a composition with hollow glass microspheres and hollow (or pre-expanded) polymeric microspheres. The composition exhibits high viscosity, low Loss Modulus, and low Loss Factor. Example 2 demonstrates a composition according to the present invention, with hollow glass microspheres and hollow (or pre-expanded) polymeric microspheres and a thermoplastic polyester. The composition exhibits high Loss Factor but has high viscosity. Example 3 demonstrates a composition according to the present invention, with expandable polymeric microspheres and a thermoplastic polyester. The composition exhibits low viscosity. Example 4 demonstrates a composition according to the present invention, with mineral fillers, hollow glass microspheres, hollow ceramic microspheres, and a thermoplastic polyester. The composition exhibits the highest Loss Modulus among the compositions, relatively high Loss Factor and maintains less than 1 gm/cc cured density. It has moderate viscosity. Example 5 demonstrates a composition according to the present invention, with mineral fillers, hollow glass microspheres, hollow ceramic microspheres, and a thermoplastic polyester. No expandable microspheres are in the composition. The composition exhibits relatively low viscosity, high Loss Modulus and a relatively high Loss Factor. Example 6 demonstrates a composition according to the present invention, with mineral fillers, hollow glass microspheres, hollow ceramic microspheres, expandable polymeric microspheres, and a thermoplastic polyester. It exhibits a relatively low viscosity and more than 50% reduction in cured material density. The composition further demonstrates a relatively high Loss Modulus and Loss Factor, Example 7 demonstrates a composition according to the present invention, with mineral fillers, hollow glass microspheres, hollow ceramic microspheres, expandable polymeric microspheres, and a thermoplastic polyester. Low percentage of cross linkers shifts loss modulus and loss factor to lower temperature peak.

| RAW MATERIAL | Example 1 | Example 2 | Example 3 | Example 4 | Example 5 | Example 6 | Example 7 |
|---|---|---|---|---|---|---|---|
| EPON 828¹ | 71.74 | 71.74 | 71.74 | 71.74 | 77.34 | 77.34 | 61.74 |
| Epon 154² | | | | | | | 10.00 |
| MICA C-3000³ | | | | 30.06 | 30.00 | 30.00 | 30.00 |
| Vansil W-10⁴ | | | | 10.02 | 10.00 | 10.00 | 10.00 |
| Borogard ZB⁵ | | | | | | | 20.00 |
| CaO⁶ | 1.60 | 2.55 | 2.30 | 2.55 | 2.55 | 2.55 | 2.55 |
| Bentone 27⁷ | 1.30 | 2.00 | 4.30 | 3.00 | 2.00 | 2.00 | 2.00 |
| Bentone 38⁸ | 1.80 | 3.00 | 4.30 | 3.00 | 3.00 | 3.00 | 3.00 |
| Epoxidized dimer acid⁹ | | | | 5.62 | | | |
| Polyurea P8091¹⁰ | 5.00 | 5.00 | 5.00 | 6.67 | 5.00 | 6.68 | 5.60 |
| DICY¹¹ | 6.68 | 6.68 | 6.68 | 6.67 | 6.68 | 8.00 | 3.30 |
| EPON 828/CTBN adduct¹² | 5.60 | 5.60 | 5.60 | | | | 5.60 |
| Extendosphere TG¹³ | | | | 24.71 | 15.00 | 15.00 | 15.00 |
| Erysis GE-35¹⁴ | 10.00 | 10.00 | 10.00 | 0.00 | 10.00 | 10.00 | 10.00 |
| Dualite U024-145D01¹⁵ | | | 5.70 | 0.00 | 0.00 | 3.80 | 7.60 |
| Cabosil M5¹⁶ | 0.50 | 0.50 | | 0.66 | 1.70 | 1.70 | 1.70 |
| VS5500 Scotchlite Glass Bubbles¹⁷ | 6.00 | 8.00 | | 24.71 | 15.00 | 15.00 | 15.00 |
| Expancel 551DE¹⁸ | 4.00 | 6.00 | | | | | |
| Diethylene glycol adipate polyester¹⁹ | 0.00 | 14.00 | 14.00 | 23.29 | 14.00 | 14.00 | 14.00 |
| CARDOLITE NC-513²⁰ | 14.00 | 14.00 | 14.00 | 13.37 | 14.00 | 14.00 | 14.00 |
| TOTAL WEIGHT | 128.219 | 149.069 | 143.619 | 226.161 | 206.269 | 213.070 | 231.090 |
| SOLIDS | 100.0% | 100.0% | 100.0% | 100% | 100.0% | 100% | 100.0% |
| WPG (WET) | 5.007 | 4.443 | 9.723 | 8.222 | 9.082 | 9.085 | 9.535 |
| Density, g/cc (wet) | 0.60 | 0.53 | 1.17 | 0.99 | 1.09 | 1.09 | 1.14 |
| Brookfield #7 spindle @ 20 RPM, cps | 180M | 180M | 6M | 41M | 20M | 20M | — |
| @60 C. | | | | | | | |

¹Diglycidyl either of Bisphenol A available from Hexion Specialty Chemicals
²Epoxy phenolie novolac resin from Hexion Specialty Chemical; s
³Commercially available from KINGS MOUNTAIN MINING LLC
⁴Calcium metasilicate from R T Vanderbilt
⁵Zn Borae from U.S. Borax
⁶commercially available from MISSISSIPPI LIME CO
⁷Rheological additive from ELEMENTIS SPECIALTIES
⁸Rheological additive from ELEMENTIS SPECIALTIES
⁹A material comprising 26.95 weight percent EMPOL 1022 which is a dimer acid sold by Cognis Emery Grp., .06 weight percent triphenyl phosphene, and 72.99 weight percent Epnon 828 - It has an acid nimber below 0.2 and an epoxy equivalent between 330 and 370
¹⁰Polyurea P8091 commercially available from PPG Industries, EMS
¹¹Dicyandiamide available from ALZ CHEM
¹²A material comprising 60 weight % Epon 828 (Hexion) and 40 weight % Hycar CTBN 1300X8 (LUBRIZOL ADVANCED MATERIALS)
¹³GLASS OXIDE, MULLITE BEADS from SPHERE ONE INC
¹⁴Castor oil glycidyl ether available from CVC Specialties.
¹⁵Isobutane incapsulated in methyl methacrylate coploymer available from Henkel
¹⁶Fumed silica available from Cabot corporation
¹⁷Hollow SODA LIME BOROSILICATE GLASS Bubbles from 3M
¹⁸Dry Expanded polymeric microspheres from Expancel
¹⁹This polyester comprise 45.4 weight percent adipic acid and 54.6 weight percent of diethylene glycol. It has a number average molecular weight ranging from 1000 to 5000, an acid value less than 10, and a hydroxy value of approximately 110.
²⁰Monofunctional epoxy flexibilizer and diluent from CARDOLITE
²¹Stearate coated precipitated calcium carbonate from SOLVAY & CIE

The coating compositions were prepared as follows: Mixing was done in a Speedmixer DC 600FVZ; mix ingredients 1 to 8 at 2350 RPM for 60 seconds. Add ingredients 9 to 13 followed by 60 second mix at 2350 RPM. Add ingredients 14 to 18 followed by 60 seconds mix at 2350 RPM. Add ingredient 19 and mix 30 second at 2350 RPM. Stir in by spatula and place the container in mix and vacuum apparatus until 28-30 in Hg vacuum is achieved.

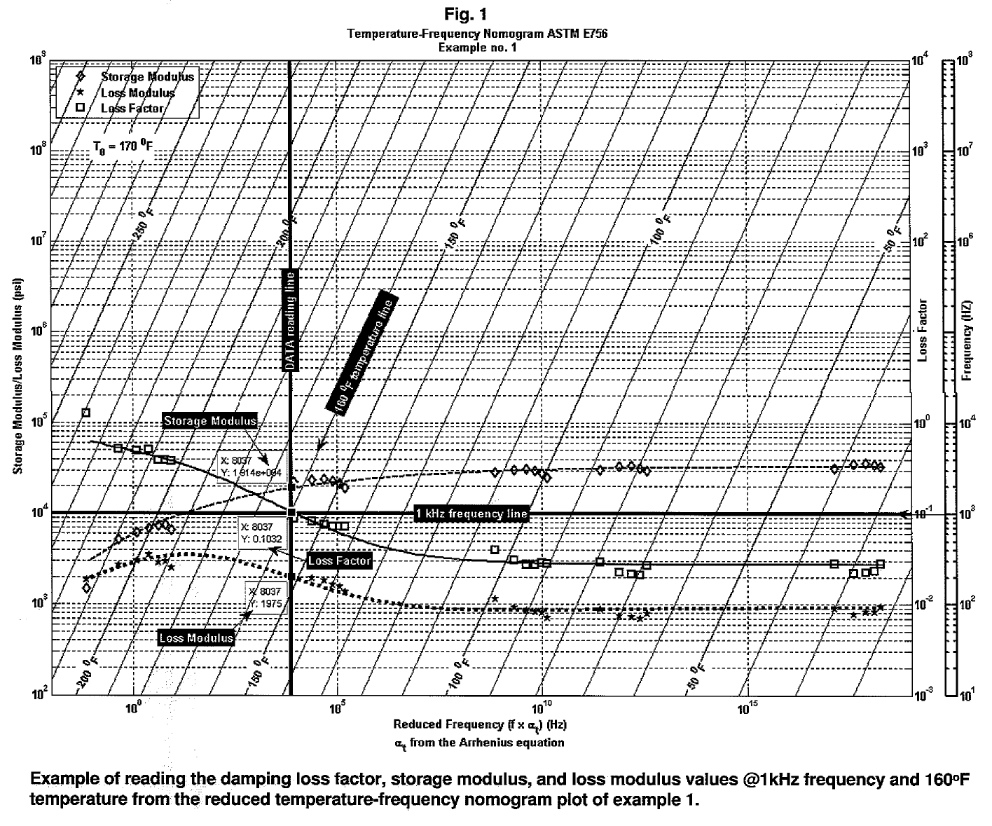

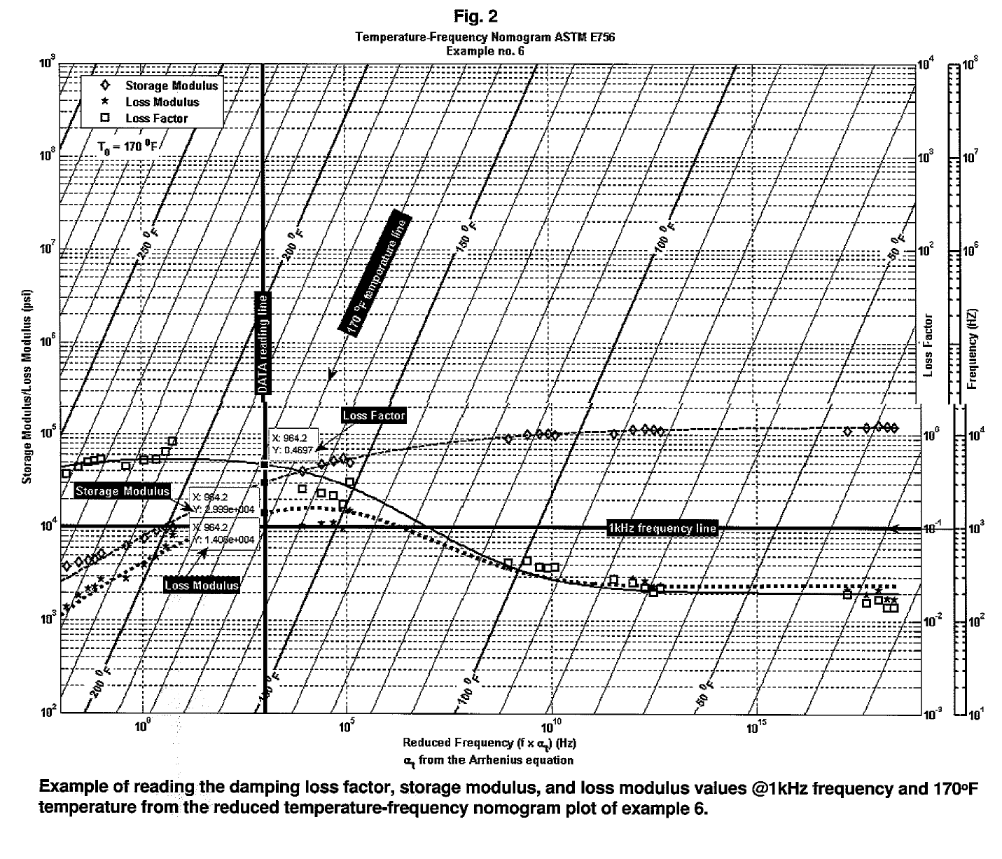

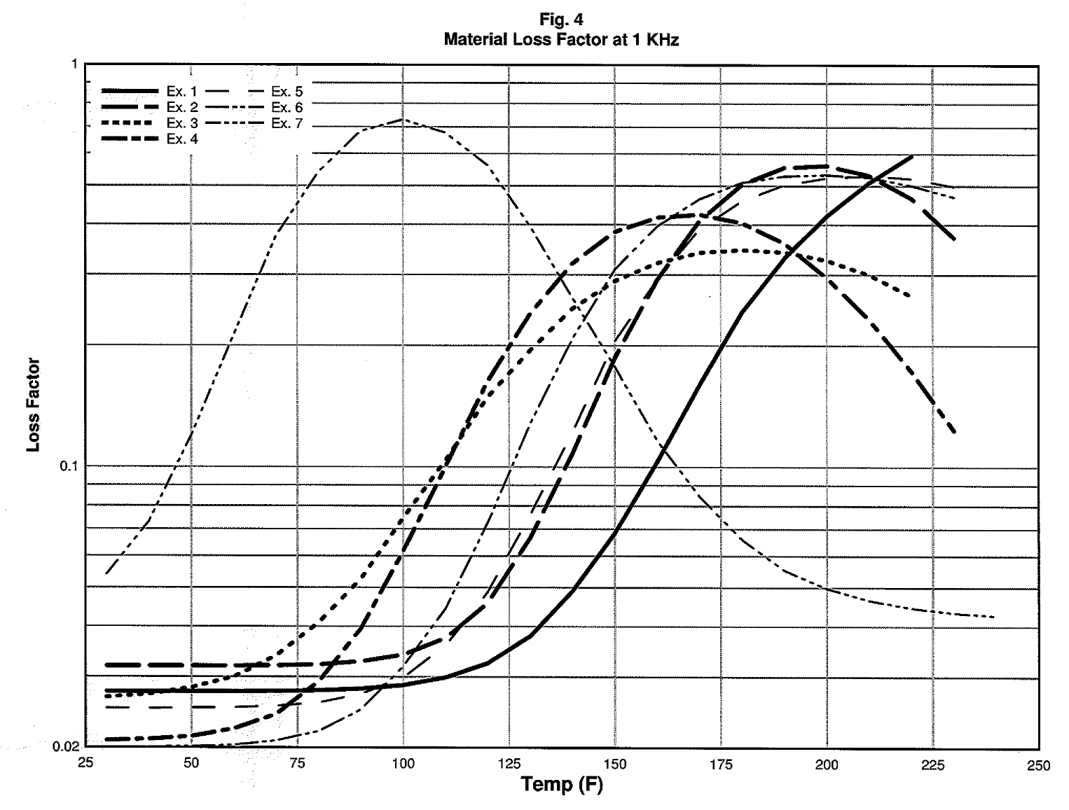

The coating compositions of each example were applied to an Oberst Bar measuring 9 inches (L)×0.5 inch (W)×0.032 inch (T) (22.86×1.27×0.081 cm). The test material was applied to an Oberst bar with a template, such that one inch (2.54 cm) of the bar on one end was left uncovered. Bars were conditioned at least 24 hours at room temperature after a 40-minute, 350° F. (177° C.) cure before grinding the excess on edges to match bar's dimensions. Composite Loss Factor (CLF) measurements were done according to ASTM E-756 using a Data Physics SignalCalc analyzer. CLF Measurements were taken for 2 to 7 modes with corresponding resonance frequencies at 0° C., 25° C., 38° C., 66° C., 93° C., and 107° C. Some automotive companies also look at interpolated CLF values at 200 Hz, 400 Hz, 800 Hz, and 1000 Hz. Composite Loss Factor data can be found in FIG. 4. CLF data are for reference only since the coating thickness and weight varies somewhat between the samples due to the purpose of varying density. Density is calculated from net weight of material on the bar and net baked thickness on bar dimension. Average thickness of 20 points on the bar is taken using PosiTector 6000 thickness gage from DeFelsko Corporation. However, it is appropriate to compare the damping performance by calculating the damping loss factor and elasticity (Young's) modulus of the material alone from measurements of the composite loss factor and resonance frequencies of a composite vibrating beam (Oberst bar test) as described in ASTM E-756. The material-only properties can be reported by plotting two or three master curves corresponding to the damping loss factor and storage/loss modulus values. This method is also known as the Reduced-Frequency Nomogram (RFN) (see FIGS. 1 and 2).

The reduced frequency nomogram (RFN) is a very compact, accurate and convenient vehicle for representing viscoelastic materials properties. Applications engineers very often use the RFN as a guide for selecting materials for designing vibration damping systems. The main advantage of using the RFN is that it permits the extrapolation of material properties data to frequency or temperature ranges where tests were not performed. Extrapolations within the frequency-temperature ranges where the vibrating beam test measurements were performed are always valid and accurate. However, extrapolations made too far outside these test ranges may be less reliable.

Reading from the reduced temperature-frequency nomogram the damping loss factor and storage/loss modulus data (FIGS. 1 & 2) @1 kHz frequency and a certain temperature of interest involves the following steps:
1. Locate the 1 kHz frequency point on the frequency axis (most right hand side vertical axis).
2. Draw a horizontal frequency line across the nomogram plot, through the 1 kHz frequency point, and extend it as far to the left as to intersect all the oblique temperature lines.
3. Locate the oblique temperature line of interest (e.g. 160° F.).
4. Through the intersection point between the horizontal 1 kHz frequency line and the oblique temperature line a vertical DATA reading line is drawn and extended upwards and downwards as far as to intersect the damping loss factor or the storage/loss modulus curves, respectively.
5. At the point of intersection between the vertical line and the respective curve of interest (e.g. damping loss factor or storage/loss modulus curves) the Y-cursor readings will provide the corresponding damping loss factor or modulus values. The scaling of the Y-cursor values corresponds to the units represented on the damping loss factor or storage/loss modulus axes respectively.
6. Material properties readings can be made at any other temperature of interest (e.g. @30° F., 40° F., 50° F., . . . etc.), by selecting the respective temperature in step three and following steps 4 through 5 accordingly.
7. After all readings of interest have been performed, corresponding data values can be tabulated (e.g. Table 1) for subsequent graphic representation and reporting.

TABLE 1
Example 6 - material data @1 kHz

| | Damping | Storage | Loss |
|---|---|---|---|
| Temp | Loss | Modulus | Modulus |
| (° F.) | Factor | (psi) | (psi) |
| 30 | 0.0200 | 121576.10 | 2432.96 |
| 40 | 0.0200 | 120496.85 | 2414.46 |
| 50 | 0.0201 | 118902.11 | 2391.08 |
| 60 | 0.0203 | 116774.98 | 2369.94 |
| 70 | 0.0208 | 113769.94 | 2365.59 |
| 80 | 0.0220 | 109980.21 | 2415.19 |
| 90 | 0.0248 | 104910.37 | 2605.27 |
| 100 | 0.0318 | 98262.59 | 3128.22 |
| 110 | 0.0443 | 91467.77 | 4055.66 |
| 120 | 0.0728 | 82388.37 | 5997.07 |
| 130 | 0.1281 | 71769.13 | 9193.03 |
| 140 | 0.2084 | 61163.19 | 12745.94 |
| 150 | 0.3096 | 50035.24 | 15489.57 |
| 160 | 0.3965 | 40222.42 | 15948.25 |
| 170 | 0.4634 | 31013.05 | 14371.50 |
| 180 | 0.5096 | 21950.33 | 11186.36 |
| 190 | 0.5291 | 15395.47 | 8146.05 |
| 200 | 0.5330 | 10906.64 | 5813.75 |
| 210 | 0.5256 | 7516.42 | 3950.87 |
| 220 | 0.5013 | 4788.74 | 2400.60 |
| 230 | 0.4692 | 3379.00 | 1585.58 |

Table 1. Example of tabulated data based on the nomogram readings shown in FIG. 2.

The most relevant single parameter for engine blade cavity filler material (described in the paper AIAA-2007-5037; 43^{rd} AIAA/ASME/SAE/ASEE

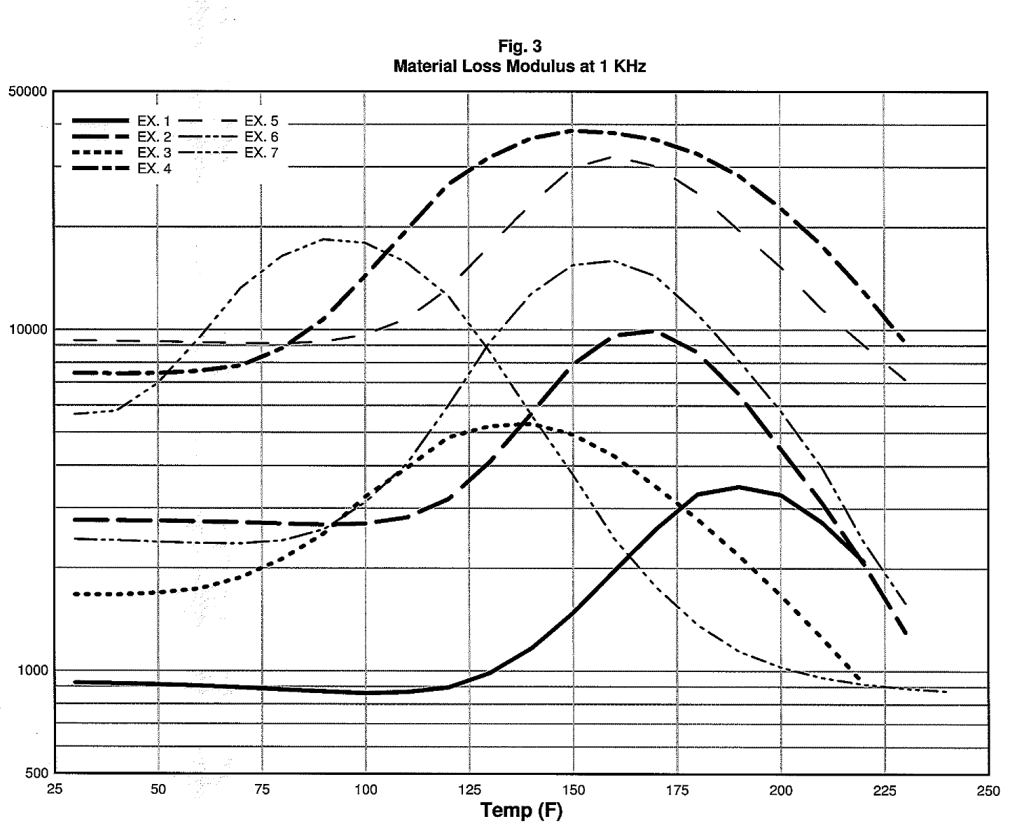

Joint Propulsion Conference & Exhibition, Cincinnati, Ohio, 8-11 Jul. 2007) is the Loss Modulus (i.e., the product of loss factor and storage modulus). Comparison is made at 1000 Hz, an intermediate frequency for all the examples over a temperature range in FIG. 3. FIG. 4 shows the Loss Factor at 1000 Hz, Note that the inventive examples show higher Modulus and Loss Factors relative to Comparative Example 1.

### Example 8

Example 8 demonstrates the preparation of a composition according to the invention with an absorption coefficient of at least 0.3 at least one frequency within the range of 100 to 6300 Hz. The test method is described in ISO 10534.

| | Parts by |
|---|---|
| RAW MATERIAL | Weight |
| EPON 828¹ | 71.74 |
| MICA C-3000³ | 30.00 |
| Extendosphere TG¹³ | 15.00 |
| Vansil W-10⁴ | 10.00 |
| Winnofil SPT²¹ | 16.00 |
| CaO⁶ | 2.55 |
| DICY¹¹ | 3.80 |
| Polyurea P8091¹⁰ | 5.60 |
| Epoxidized dimmer acid⁹ | 5.60 |
| Bentone 27⁷ | 3.00 |
| Bentone 38⁸ | 3.00 |
| Erysis GE-35¹⁴ | 10.00 |
| Cabosil M5¹⁶ | 1.70 |
| Dualite U024-145D01¹⁵ | 7.60 |
| VS5500 Scothlite Glass Bubbles¹⁷ | 15.00 |
| Diethylene glycol adipate polyester¹⁹ | 35.00 |
| CARDOLITE NC-513²⁰ | 8.00 |

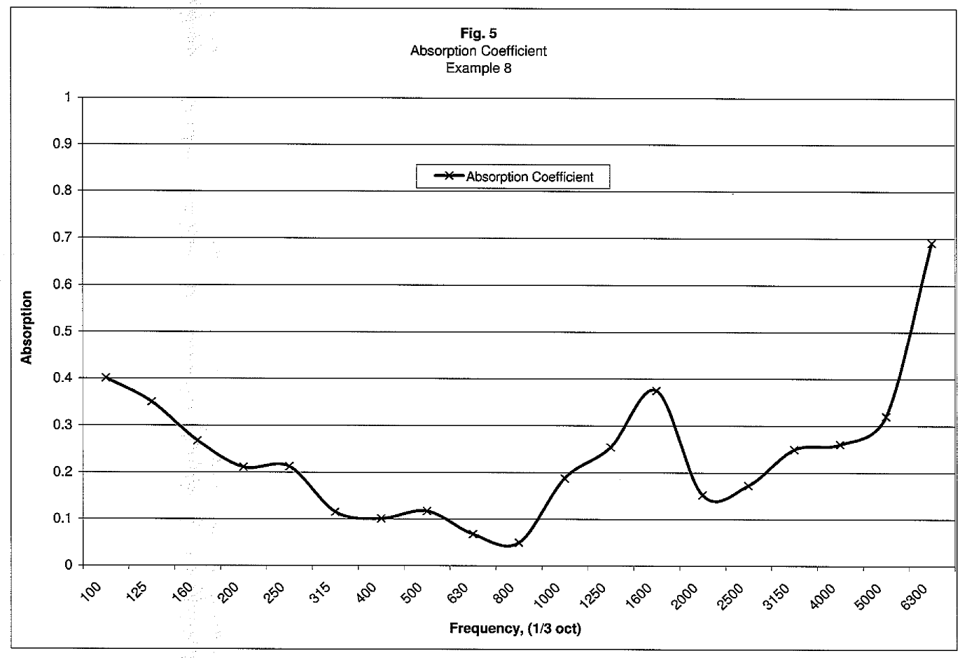

The composition was applied to a MYLAR film at a wet thickness of 2 mm and cured at 350° F. (176.7° C.) for 30 minutes. FIG. 5 illustrates a graph of the absorption coefficient for the composition of Example 8.

Whereas particular embodiments of this invention have been described above for purposes of illustration, it will be evident to those skilled in the art that numerous variations of the details of the present invention may be made without departing from the scope of the invention as defined in the appended claims.

What is claimed is:

1. A curable composition comprising:
(a) a polyepoxide containing at least two epoxide groups per molecule;
(b) a thermoplastic polyester polymer;
(c) a curing agent having functional groups reactive with the epoxide groups in (a);
(d) a mineral filler; and
(e) microspheres comprising expandable microspheres which expand during curing of the composition and/or hollow microspheres;
wherein upon curing, the composition demonstrates a Material Loss Modulus of at least 2000 PSI at least one point within the temperature range of 32° F. (0° C.) to 225° F. (107.2° C.) and at 1 KHz frequency, and wherein the density of the cured composition is less than 1 g/cc.

2. The curable composition of claim 1 wherein the composition contains expandable microspheres and wherein upon curing, the density of the composition is less than half of the density of the composition before curing.

3. The curable composition of claim 1 wherein upon curing, the composition demonstrates a Material Loss Modulus of at least 2000 PSI within the temperature range of 75° F. (23.9° C.) to 165° F. (73.9° C.) and at 1 KHz frequency.

4. The curable composition of claim 1 wherein upon curing, the composition demonstrates an absorption coefficient of 0.3 or greater at least one frequency within the range of 100 to 6300 Hz.

5. The curable composition of claim 1 wherein upon curing, the composition demonstrates a peak Material Loss Modulus below 175° F. (79.4° C.) at 1 KHz frequency.

6. The composition according to claim 1, wherein the polyepoxide comprises an epoxy polyether, a polyglycidyl ether of one or more polyhydric alcohols, a polyglycidyl ester of one or more polycarboxylic acids, epoxidated olefinically unsaturated alicyclic compounds, a polyepoxide containing oxyalkylene groups, and/or an epoxy novolac resin.

7. The composition according to claim 6, wherein the polyepoxide comprises a polyglycidyl ether of Bisphenol A.

8. The composition according to claim 1, wherein the polyepoxide is present in an amount ranging from 15 to 85 weight percent based on the total weight of the composition.

9. The composition according to claim 1, wherein the thermoplastic polyester polymer is substantially free of aromatic units.

10. The composition according to claim 1, wherein the thermoplastic polyester polymer does not react chemically with other components of the composition.

11. The composition according to claim 1, wherein the thermoplastic polyester polymer is present in an amount ranging from 1 to 45 weight percent based on the total weight of the composition.

12. The composition according to claim 1, wherein the curing agent comprises dicyandiamide, polyurea, an aliphatic polyfunctional amine, a cycloaliphatic polyfunctional amine, an aromatic polyfunctional amine, and/or a polyamide.

13. The composition according to claim 1, wherein the curing agent is present in the composition in an amount ranging from 1.3 to 15 percent by weight, based on the total weight of the composition.

14. The composition according to claim 1, wherein the mineral filler comprises clay, mica, dolomite, talc, magnesium carbonate, calcium carbonate, precipitated calcium carbonate, zinc borate, calcium silicate, and/or calcium metasilicate.

15. The composition according to claim 1, wherein the mineral filler is present in an amount ranging from 5 to 40 percent by weight based on the total weight of the composition.

16. The composition according to claim 1, wherein the composition contains expandable microspheres that have a particle size ranging from 2 to 50 microns prior to incorporation into the composition.

17. The composition according to claim 1 wherein the composition is extrudable.

18. The composition according to claim 1, wherein the composition contains hollow microspheres comprising hollow glass and/or ceramic microspheres having rigid shells.

19. A curable composition comprising:
(a) a polyepoxide containing at least two epoxide groups per molecule;
(b) a thermoplastic polyester polymer;
(c) a curing agent having functional groups reactive with the epoxide groups in (a); and
(d) microspheres comprising expandable microspheres which expand during curing of the composition and/or hollow microspheres;
wherein upon curing, the composition demonstrates a Material Loss Factor of at least 0.04 at least one point within the temperature range of 115° F. (46.1° C.) to 225° F. (107.2° C.) and at 1 KHz frequency, and wherein the density of the cured composition is less than 1 g/cc.

20. The curable composition of claim 19 wherein the composition contains expandable microspheres and wherein upon curing, the density of the composition is less than half of the density of the composition before curing.

21. The curable composition of claim 20 wherein upon curing, the composition demonstrates a Material Loss Modulus of at least 2000 PSI at least one point within the temperature range of 75° F. (23.9° C.) to 165° F. (73.9° C.) and at 1 KHz frequency.

22. The curable composition of claim 1 wherein the composition is a two-package composition and the curing agent is present in an amount of 1 to 50 percent by weight, based on the weight of polyepoxide present in the composition.
